(19) United States
(12) Patent Application Publication
(10) Pub. No.: US 2013/0346875 A1
(43) Pub. Date: Dec. 26, 2013

(54) Personalized Interactive Entertainment Profile

(71) Applicants: Christian Klein, Duvall, WA (US); Zachary Mark Gutt, Seattle, WA (US); Kalen Lily Wong, Renton, WA (US); Sheridan Leigh Martin, Seattle, WA (US)

(72) Inventors: Christian Klein, Duvall, WA (US); Zachary Mark Gutt, Seattle, WA (US); Kalen Lily Wong, Renton, WA (US); Sheridan Leigh Martin, Seattle, WA (US)

(73) Assignee: MICROSOFT CORPORATION, Redmond, WA (US)

(21) Appl. No.: 13/528,036

(22) Filed: Jun. 20, 2012

(51) Int. Cl. G06F 3/01

(52) U.S. Cl. 715/745

(57) ABSTRACT

Described is a technology by which an entity's (e.g., a user's or group's) usage of a digital entertainment service is used to automatically generate an interactive, personalized three-dimensional visualization representing the entity's career on a digital entertainment service. Usage events are collected as profile information, which is processed to generate the visualization, as well as to automatically theme the user's experience. Filtering and prioritization of data within the profile information is performed based on the predicted degree of interest to the entity and to others; the entity may provide preference data to vary the automatically generated visualization and/or theme.

### BACKGROUND

Digital entertainment systems, such as gaming consoles, can display sophisticated three-dimensional (3D) environments with which a user interacts. However, such 3D environments generally focus only on game play or on interaction with other people. Other aspects of such systems are not part of these interactive environments. For example, user profiles on digital entertainment systems/services such as Xbox® LIVE, which are generally created manually by each user, have limited impact on the user's own experience, and are primarily text information.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which profile information of an entity such as a user or group is automatically used to provide a visualization and/or theme related to the entity's usage of a digital entertainment service. A data collector collects events related to usage of the digital entertainment service by the entity, to maintain profile information for the entity based upon those events. A visualization mechanism processes the profile information into profile results capable of being rendered as a visualization, such as in a three dimensional environment. A theme mechanism may process the profile information into a thematic profile results, for use in theming.

In one aspect, there is described generating theming data and visualization data based upon profile information of an entity, the profile information corresponding to events of the entity with respect to interaction with a digital entertainment service. The theming data may be used to provide audio, visual, or audiovisual output data to provide a theme for output. The visualization data may be provided for output.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components of system including a digital entertainment service that processes profile information into a personalized entertainment profile for visualization in an interactive 3D environment, according to one example implementation.

FIG. 2 is a block diagram showing additional aspects of profile-based themes and visualizations, according to one example implementation.

FIG. 3 is a flow diagram representing example steps that may be taken to generate themes and/or visualizations generally based upon profile information, according to one example implementation.

FIG. 4 is a block diagram representing an example computing environment, in the form of a gaming system, into which aspects of the subject matter described herein may be incorporated.

### DETAILED DESCRIPTION

Various aspects of the technology described herein are generally directed towards an integrated user entertainment profile that provides a digital record of an entity's (e.g. a user's or group's) career on a digital entertainment service such as Xbox® LIVE. The technology facilitates the personalization of a user experience, and provides a straightforward mechanism for creating more relevant and complete public identities on the service. For example, the interactive entertainment profile may build on existing user profile, theming and gaming rewards concepts to provide an extensive, more visually immersive and more personal experience.

In one aspect, the technology provides an interactive and personalized visualization (e.g., a representation in a three-dimensional environment, which may include accompanying audio) of a user profile representing a user's career on a digital entertainment service. Note that “digital entertainment service” with respect to an entity's usage, career and the like includes offline usage on a digital entertainment system (e.g., console) or other device resulting in events that are later collected by/uploaded to the service. The profile may include information about various digital media types and activities, including games, videos, music, communication with other users and the consumption of applications or web sites. The profile information further may be used to automatically theme the user's experience on one or more devices, as described herein. Explicit user customization may be combined with implicit adaptation (based on usage and other factors such as other information and time), and/or with the user's social graph to provide the profile, such as through the use of dynamic filtering and prioritization of data (e.g. gaming accomplishments) within the profile based on a predicted degree of interest to the user and to his or her friends.

In one aspect, an interactive browser of the profile combined with an automated guided tour may be provided, each providing a categorized view of the user's career on the service. The user may specify a subset of the various profile information to form that user's public-facing profile on the service, e.g., instead of starting with a blank slate, the user may start with the profile data and mark selected portions/items of the profile data as public, as well as add to the actual profile data with augmented data directed to public. A multi-user profile, such as a single combined family profile, a group of friends who play games as a team, and so forth, also may be provided. It is also feasible for the service to automatically create profile results for a group of unrelated/anonymous users such as selected randomly or based upon some skill level or other common attribute, e.g., the actual profile information of a number of expert-level gamers may be used to generate a visualization of game playing events and highlights, such as to help advertise/market a game by showing highlights of what a user is capable of experiencing in that game.

It should be understood that any of the examples herein are non-limiting. For instance, while a gaming system and service is generally exemplified, the technology may work with any computing device such as a personal computer, smartphone and/or tablet computer. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used in various ways that provide benefits and advantages in computing and user profiles in general.

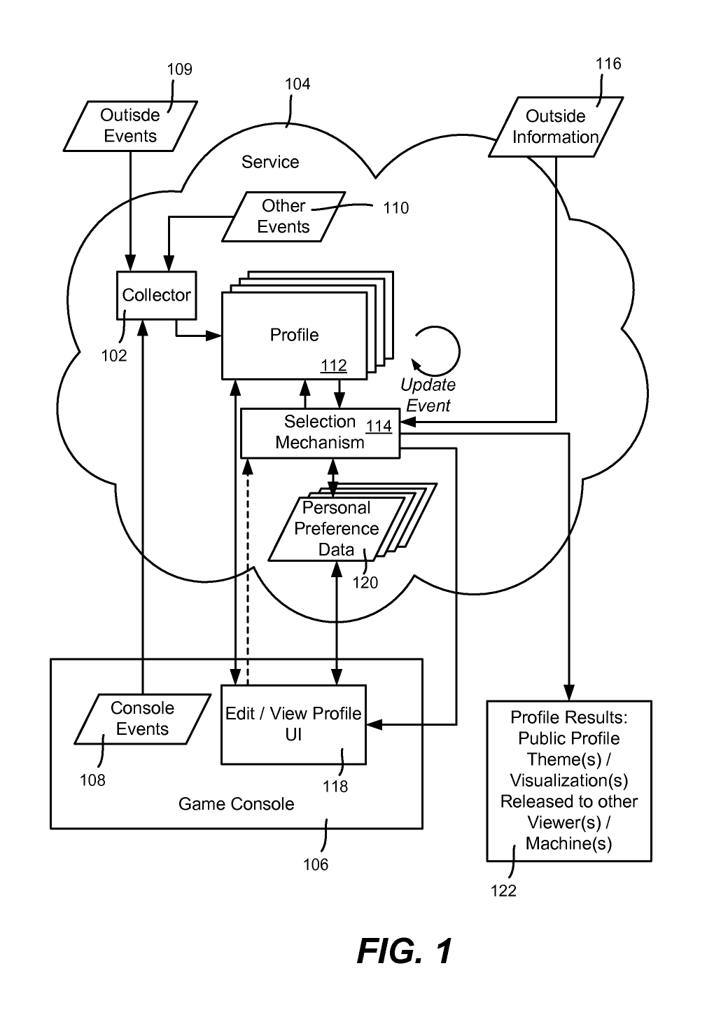

FIG. 1 shows a block diagram in which a data collector 102 gathers usage information corresponding to a user identity over time for each user of a service 104, such as an online digital entertainment service. In general, as the user engages with the entertainment service 104 via a console 106, the console 106 keeps a record of console events 108 which may comprise a wide range of statistics and other information to characterize the user's usage of the console 106 and service 104. Examples of such console events 108 (usage data) may include (but are not limited to) videos or music consumed, including statistics related to genres, actors/artists, release dates, and so forth, and game-related data, such as gaming achievements, game and level completions, high scores, calories burned and similar accomplishments. Other non-limiting examples may include game videos and screenshots of noteworthy moments that are automatically recorded during gameplay, and a record of social interactions, such as communicating, sharing or recommending content. Further, events may include a record of transactions and personalizations on the service, such as purchasing a new game or changing an avatar's appearance, and so forth. Gifts given by and received by the user may also be part of the console events 108 that is collected by the collector 102. Still further, the user's social graph including with whom the user has interacted, at what level (e.g., co-player, friend or coworker as specified by the user), and possibly how often, may be part of the usage data. This usage data may comprise outside events 109, such as similar events collected from a different device or devices, and other events 110.

This collected data (or some part thereof) is kept by the service 104 in profile information 112, e.g., per-user or group of users, and forms a digital history of each user's career. Note that heretofore a user's history on the service and the personal profile were disconnected concepts. Gaming rewards systems (such as Xbox® LIVE Achievements) were only relevant to a subset of users and did not contribute to other aspects of that user's profile. Similarly, theming and personalization were not part of the profile except for basic personalization such as a gamer tag (text name), and other data manually entered by a user (e.g., name, motto, bio or location data).

The console events 108 may be cached locally and uploaded into the profile information 112 via the collector whenever the user is online, and/or periodically. A local copy of the profile information 112 or a subset of the information therein also may be kept by the game console 106 and/or a storage device coupled thereto.

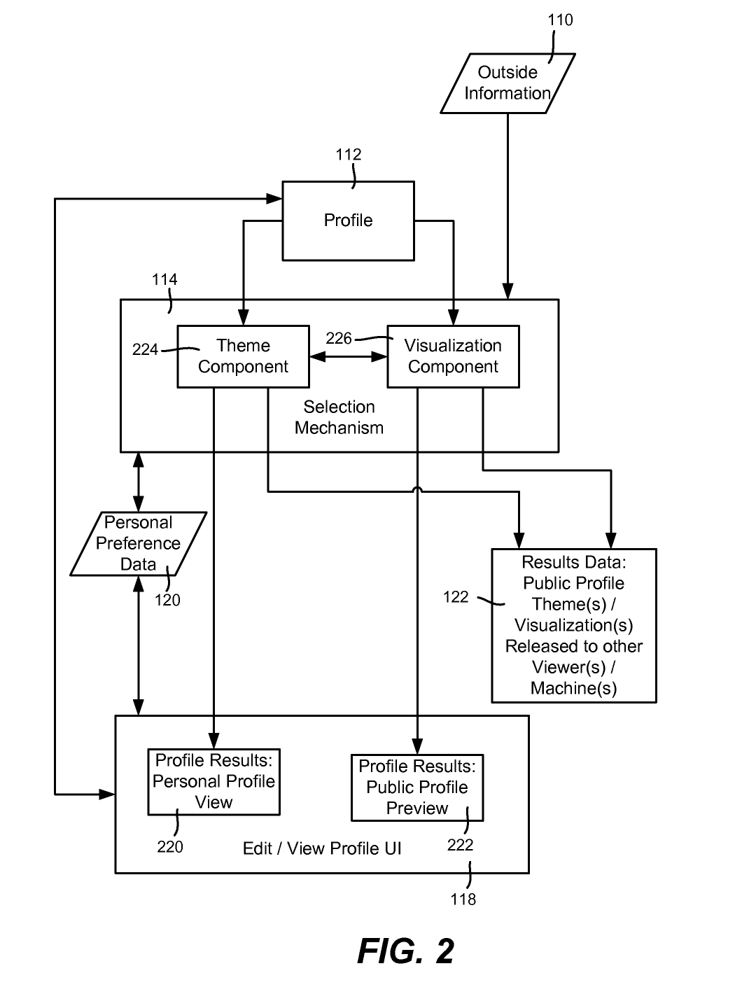

Further represented in the example implementation of FIG. 1 is a selection mechanism 114 comprising a mechanism that automatically filters and prioritizes the profile information 112, and also may classify the information. For example, the profile information 112 may contain a lot of data that is not likely significant, or at least not yet significant, which a filter portion may separate out from further processing, including prioritization. A prioritizer portion prioritizes which pieces of information are most likely to be personally significant to the user and to their friends, which correspond to predicted profile results. One example selection mechanism may be based upon machine learning, such as to process features extracted from the profile information to select and rank content for inclusion in the profile results (e.g., one type of profile results 122 is shown in FIGS. 1 and 2 as one or more public profile themes/visualizations) capable of being rendered including viewed as described herein.

By way of example, the selection mechanism 114 may prioritize achievements and other interesting moments that are predicted to be likely of interest to the user and others, such as prioritizing achievements that are first, last or unique within the user's social graph or the service at large (because the user is more likely interested in representing themselves in a unique way). The selection mechanism 114 may prioritize content, genres and other collections in which the user has invested the most time. The selection mechanism 114 may prioritize content that the user has chosen to share, rate, recommend, read more about, or otherwise engage in beyond simple consumption. Note that recent data in the profile information 112 may be weighted more than older data, e.g., a user may have had a strong interest in a particular game/movie at one time, but as the interest fades away, by considering timing of events, the filtering and prioritizing reflects new interests and deemphasizes prior interests.

In addition to user-generated events, outside information 116 may factor into the prediction computations of the selection mechanism 114. For example, a news event regarding a particular musician may make the data in the user's profile associated with that musician more significant. As another example, a change in statistics regarding a game achievement may make that achievement less significant (initially a particular achievement was rare, however now many players have achieved the same feat). Outside information may be used to highlight an event, such as to emphasize data in a profile to market an upcoming game release to those who have played the previous game in that series. The outside information can correspond to events among a social circle of friends, among people with similar interests, or the population in general.

Note that any of the components shown in the service 104 in FIG. 1 may be run, at least in part, in the console 106. For example, as described above, a collector-like component may run in the game console 106 to collect events when the console is offline, or to cache events for later uploading, generally for purposes of efficiency. Further, at least some of the filtering/prioritization may be performed on the console 106, with full or partial results uploaded to the service 104, again generally for purposes of efficiency.

For many users, automatic filtering and prioritization, as well as classification, may be only a starting point. A user may want certain profile information considered more significantly or less significantly than what predictions resulted from the automatic operations. For example, certain users may have unusual definitions of movie genres, or may feel passionate about a gaming moment even though that moment was not determined by the selection mechanism 114 to be particularly noteworthy. As another example, a user may want to remove something that the automatic process of the selection mechanism 114 included, e.g., a serious gamer may not want his friends to know that he also enjoys romantic comedies.

To provide the user with this ability, the user may interact with the profile information 112 via an edit profile user interface (UI) program 118 on the console (or other device), such as a browser, so that the user may vary (e.g., influence and/or override) the profile results of the selection mechanism 114 and/or customize the profile information 112 so as to vary those results. More particularly, via the program 118, users that are interested in explicit customization may further change their profile set or its resultant output via personal preference data 120 to better reflect their own mental models and priorities. Customizing the profile information 112 also provides for more accurate and/or personally relevant theming and visualizations, as described below.

Machine learning may be used to provide the selection mechanism 114, e.g., as a learned algorithm including ranking functionality. This selection mechanism 114 may be tuned based upon feedback (e.g., as represented by the dashed line) from actual user changes to the predicted profile results of the selection mechanism 114.

Note that while FIG. 1 is shown as providing the personal preference data 120 for use by the selection mechanism 114 in providing profile results for visualizations, other mechanisms are feasible. For example, a user may user an application program or browser component to more directly edit his or her profile information 112, including via a program run on a device such as a personal computer or smartphone that is different from the device (e.g., the game console 106) where most of the events are collected.

Turning to aspects related to themes, using the profile information 112, the service (e.g., a theme component 224 in the selection mechanism 114 as shown in FIG. 2) provides a mechanism that may automatically theme various aspects of the user's experience on the service 104. The theme may be experienced as any audio, visual and/or audiovisual output. For example, the service may show a screenshot or video picture frame of a key moment hanging on a virtual wall in the user's 3D space, provide virtual taxidermy such as to create a 3D statue or trophy of a defeated enemy or other relevant object. The user's avatar may appear to be set in a location that corresponds to the user's preferences (e.g., placing a sports fan in a stadium). The service may theme the user's wallpaper, colors, fonts, sounds, and so forth to match favorite content and/or genres. Music and/or other audio (e.g., actual sounds recorded during game play) may also be themed based upon the profile information. As with other automatic selection aspects, the user may edit/influence/override the thematic selections chosen by the service.

In addition to theming, various interactive 3D visualizations may be created from the user's profile information. Example visualizations may include an interactive browser that classifies the profile information into 3D regions (e.g. corresponding to time periods or content genres) and allows the user to actively explore the user's profile; (note that this browser may also comprise the UI for customizing the data set). For example, the profile may be divided into 3D regions that each may include pictures on the walls and music that emphasize a theme for that particular region. A user may navigate through the various regions, or the regions may change in time, be tiled and so forth so that the user can separately view each region.

A screensaver experience may be based upon the profile information 112 (e.g., whether as a theme and/or a visualization) to decorate the display when no one is actively using the system, and to show relevant information to attract the user back to engaging with the system. Profile-based music and/or other audio may also be provided in combination with the screen saver.

Yet another interactive, immersive 3D environment visualization may comprise a guided tour that provides a curated video presentation of the profile information 112. The tour may be arranged by time, so that a user moves through her history from long past events towards more current events. Such a tour may be shared with others, although as described below, a user may see a personal tour that is different from a tour experienced by others. The tour may be placed in any of various environments, e.g., as a museum-like tour, as a tour on a mountain on which the viewer “skis” through the visualization, and so forth, which may be selected by the user preference data and/or by the viewer.

As generally represented in FIG. 2, different 3D profile visualizations based upon the profile information 112 and the personal preference data 120 (and possibly the outside events 109) may be provided, using virtually any criteria to differentiate which profile theme/visualization is seen by whom, when, on what device, and so forth. Criteria may include whether the profile theme/visualization is public or private, as represented in FIGS. 1 and 2 as different types of profile results 122 and 220, respectively. Multiple public profile themes/visualizations may be provided, e.g., by having different themes/visualizations for friends, work colleagues, acquaintances, persons with similar interests, or the general public. Other criteria my include time of day, day of week, holidays, the output device (e.g., a personal profile visualization may show more content on the user's own device than if output on another device), the user's mood, the user's presence or absence, and so forth.

FIG. 2 shows a separate theme component 224 and a visualization component 226 incorporated as mechanisms into (or otherwise associated with) the selection mechanism 114. The user can see a personal profile view (block 220) with different theming/visualization from that presented in the public view profile results 122. Different sets of public themes and/or public visualizations may be provided depending on criteria (e.g., friends versus the general public) as described above.

Further, the user may preview (block 222) any public content, such as before that content becomes viewable by another viewer/on another machine. For example, the user may configure the personal preference data 120 so that the service 104 does not release a changed visualization/theme publicly, regardless of new events and other information, unless explicitly released by the user after previewing the pending changed output.

As can be seen, instead of having the user manually enter information into a blank form or the like, the service automatically collects and processes events and other information to create personal and public profile results, which may be used as is or as a starting point. The user can reprioritize, amend or remove information to create the public profile (or profiles) that best represents how he or she wants to be viewed by others. Like the original data set, this public version (or versions) of the profile supports the same rich visualizations. The user can do the same with information for the private profile results.

Turning to another aspect, multiple people (or groups) may jointly create a profile. More particularly, instead of events from a single user entity, events can come from an entity comprising multiple users. For example, groups of users such as families may jointly create and manage an entertainment profile that captures their shared personalities and history on the service. By default, the system prioritizes data that the group's individuals have in common, while additionally adding smaller details that highlight each individual's uniqueness. The shared profile may include all information related to each individual member of that group, or may include only information related to times when all members are using the service together.

To this end, the above described mechanisms and features are applicable to multi-user entity profiles, including tracking the usage history including significant moments and the like for multiple users. A shared experience may be themed with the collective profile information (e.g. to a shared console in the living room), and/or an interactive 3D group profile may be visualized. A public-facing group profile may be created.

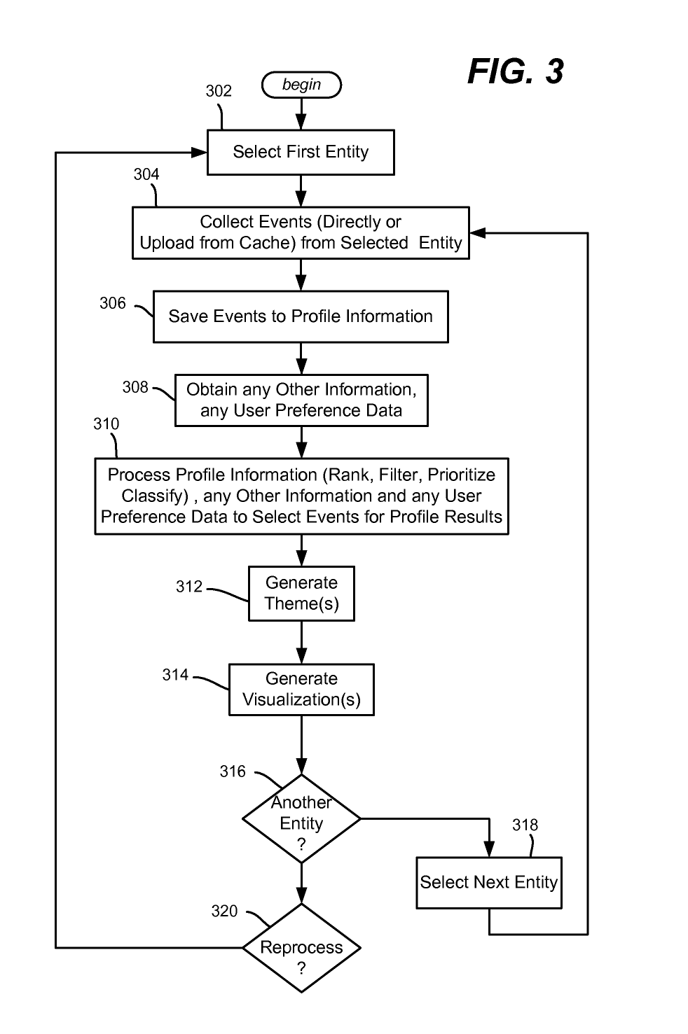

FIG. 3 is a flow diagram summarizing some of the above concepts and aspects via example steps. In FIG. 3, the selection mechanism is run for some set of entities, such as all entities or only those entities for whom there has been some event or events, outside information and/or personal preference data change that may change the profile results relative to previous profile results. The example steps may be run periodically, in which case time may be a factor in changing the profile results.

Step 302 represents selecting an entity, with step 304 representing collecting the events from that entity and step 306 representing saving those events to the entity's profile information. Note that collection and saving may be ongoing and need not be part of the selection process of FIG. 3, although an online synchronization with any local events cached at the entity's console, if possible, may be desirable via steps 304 and 306 or the like so that any events of the entity that recently occurred are reflected in the next instance of the profile results.

Step 308 represents the selection mechanism obtaining any other outside information and/or any personal preference data of the entity so that such data may be factored into the selection process. As described above, this other information may be a news event, marketing information, and so forth, while the preference data may include influencing-type suggestions, specific overrides, public versus private directives, and so forth, both of which varies the profile results that are output by the selection mechanism.

Step 312 represents generating the theme or themes (e.g., by the theme component 224 of FIG. 2) based upon the profile information, any outside information and any personal preference data. Step 314 represents generating the visualization or visualizations (e.g., by the visualization component 226 of FIG. 2) based upon the profile information, any outside information and any personal preference data. Note that each visualization provides a set of profile results, and may include a corresponding theme obtained via step 312. At this time, each visualization may be output as the profile results for rendering as described above, e.g., if specified in the preference data, at least one private visualization and at least one public visualization may be viewed (as well as heard, as a “visualization” also may include audio). Note that as described above, an entity may preview any public visualization before allowing its content to be released for public viewing.

Step 316 repeats the process for another selected entity. Note that parallel processing may be used to speed up the processing as appropriate for possibly many thousands or millions of entities. Step 320 represents repeating the processing at some other appropriate time, such as periodically (e.g., hourly, daily). The process also may be re-run on demand, e.g., as a user interacts to modify personal preference data and/or the user's profile information, or achieves a new significant event, the process may be re-run by user request or other triggering mechanism so that the user receives an updated visualization relatively quickly.

### Example Operating Environment

It can be readily appreciated that the above-described implementation and its alternatives may be implemented on any suitable computing device, including a gaming system, personal computer, tablet, smartphone and/or the like. For purposes of description, a gaming (including media) system is described as one example operating environment hereinafter.

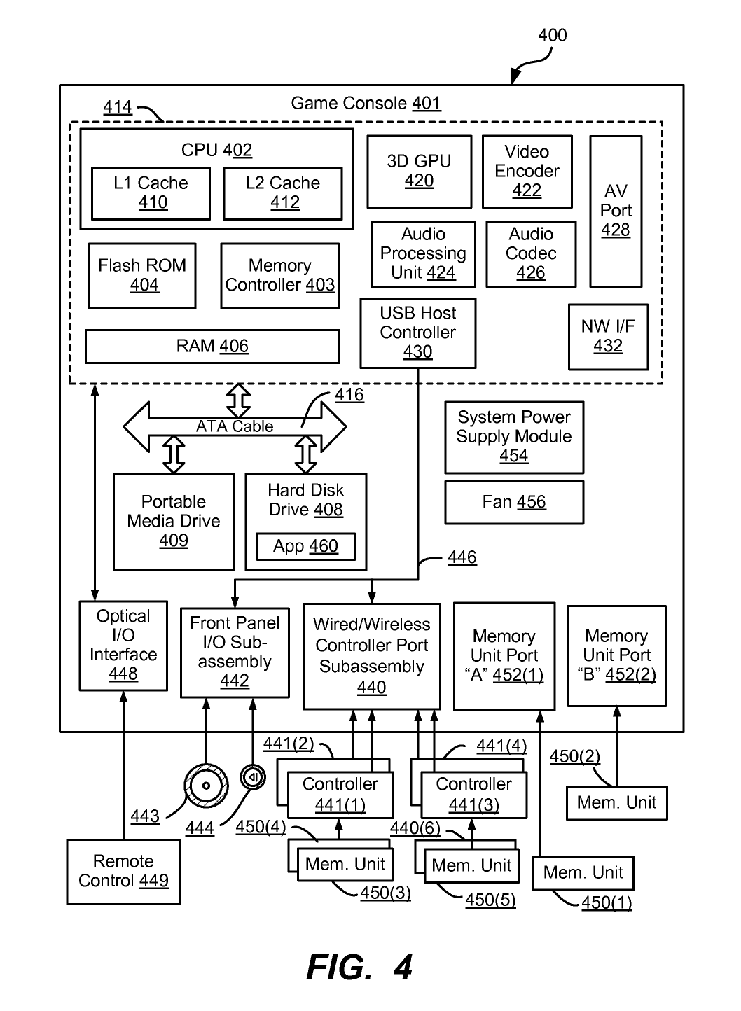

FIG. 4 is a functional block diagram of gaming and media system 400 and shows functional components in more detail. Console 401 has a central processing unit (CPU) 402, and a memory controller 403 that facilitates processor access to various types of memory, including a flash Read Only Memory (ROM) 404, a Random Access Memory (RAM) 406, a hard disk drive 408, and portable media drive 409. In one implementation, the CPU 402 includes a level 1 cache 410, and a level 2 cache 412 to temporarily store data and hence reduce the number of memory access cycles made to the hard drive, thereby improving processing speed and throughput.

The CPU 402, the memory controller 403, and various memory devices are interconnected via one or more buses (not shown). The details of the bus that is used in this implementation are not particularly relevant to understanding the subject matter of interest being discussed herein. However, it will be understood that such a bus may include one or more of serial and parallel buses, a memory bus, a peripheral bus, and a processor or local bus, using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

In one implementation, the CPU 402, the memory controller 403, the ROM 404, and the RAM 406 are integrated onto a common module 414. In this implementation, the ROM 404 is configured as a flash ROM that is connected to the memory controller 403 via a Peripheral Component Interconnect (PCI) bus or the like and a ROM bus or the like (neither of which are shown). The RAM 406 may be configured as multiple Double Data Rate Synchronous Dynamic RAM (DDR SDRAM) modules that are independently controlled by the memory controller 403 via separate buses (not shown). The hard disk drive 408 and the portable media drive 409 are shown connected to the memory controller 403 via the PCI bus and an AT Attachment (ATA) bus 416. However, in other implementations, dedicated data bus structures of different types can also be applied in the alternative.

A three-dimensional graphics processing unit 420 and a video encoder 422 form a video processing pipeline for high speed and high resolution (e.g., High Definition) graphics processing. Data are carried from the graphics processing unit 420 to the video encoder 422 via a digital video bus (not shown). An audio processing unit 424 and an audio codec (coder/decoder) 426 form a corresponding audio processing pipeline for multi-channel audio processing of various digital audio formats. Audio data are carried between the audio processing unit 424 and the audio codec 426 via a communication link (not shown). The video and audio processing pipelines output data to an A/V (audio/video) port 428 for transmission to a television or other display. In the illustrated implementation, the video and audio processing components 420, 422, 424, 426 and 428 are mounted on the module 414.

FIG. 4 shows the module 414 including a USB host controller 430 and a network interface (NW I/F) 432, which may include wired and/or wireless components. The USB host controller 430 is shown in communication with the CPU 402 and the memory controller 403 via a bus (e.g., PCI bus) and serves as host for peripheral controllers 434. The network interface 432 provides access to a network (e.g., Internet, home network, etc.) and may be any of a wide variety of various wire or wireless interface components including an Ethernet card or interface module, a modem, a Bluetooth module, a cable modem, and the like.

In the example implementation depicted in FIG. 4, the console 401 includes a controller support subassembly 440, for supporting four game controllers 441(1)-441(4). The controller support subassembly 440 includes any hardware and software components needed to support wired and/or wireless operation with an external control device, such as for example, a media and game controller. A front panel I/O subassembly 442 supports the multiple functionalities of a power button 443, an eject button 444, as well as any other buttons and any LEDs (light emitting diodes) or other indicators exposed on the outer surface of the console 401. The subassemblies 440 and 442 are in communication with the module 414 via one or more cable assemblies 446 or the like. In other implementations, the console 401 can include additional controller subassemblies. The illustrated implementation also shows an optical I/O interface 448 that is configured to send and receive signals (e.g., from a remote control 449) that can be communicated to the module 414.

Memory units (MUs) 450(1) and 450(2) are illustrated as being connectable to MU ports “A” 452(1) and “B” 452(2), respectively. Each MU 450 offers additional storage on which games, game parameters, and other data may be stored. In some implementations, the other data can include one or more of a digital game component, an executable gaming application, an instruction set for expanding a gaming application, and a media file. When inserted into the console 401, each MU 450 can be accessed by the memory controller 403.

A system power supply module 454 provides power to the components of the gaming system 400. A fan 456 cools the circuitry within the console 401.

An application 460 comprising machine instructions is typically stored on the hard disk drive 408. When the console 401 is powered on, various portions of the application 460 are loaded into the RAM 406, and/or the caches 410 and 412, for execution on the CPU 402. In general, the application 460 can include one or more program modules for performing various display functions, such as controlling dialog screens for presentation on a display (e.g., high definition monitor), controlling transactions based on user inputs and controlling data transmission and reception between the console 401 and externally connected devices.

The gaming system 400 may be operated as a standalone system by connecting the system to high definition monitor, a television, a video projector, or other display device. In this standalone mode, the gaming system 400 enables one or more players to play games, or enjoy digital media, e.g., by watching movies, or listening to music. However, with the integration of broadband connectivity made available through the network interface 432, gaming system 100 may further be operated as a participating component in a larger network gaming community or system.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A system comprising,
a data collector configured to collect events related to usage of a digital entertainment service by an entity, and to maintain profile information for the entity based upon those events; and
a visualization mechanism configured to process the profile information into profile results capable of being rendered as a visualization.

2. The system of claim 1 further comprising a theme mechanism configured to process the profile information into a thematic profile results, for inclusion as at least one theme in the profile results that are capable of being rendered as a visualization.

3. The system of claim 1 further comprising a theme mechanism configured to process the profile information into a thematic profile results comprising at least one of: a screensaver, a screenshot, one or more picture frame representations, virtual taxidermy, a location setting, wallpaper, colors, fonts, or audio.

4. The system of claim 1 further comprising a user interface program configured to provide personal preference data that varies the profile results.

5. The system of claim 4 wherein the user interface program is further configured to provide a mechanism to generate a set of profile results corresponding to a public-facing profile on the service.

6. The system of claim 1 wherein the entity comprises a group of users, and wherein the data collector collects events from each user of the group.

7. The system of claim 1 wherein the results data is rendered into an interactive personalized 3D visualization representing at least part of the entity's career with respect to usage of the digital entertainment service.

8. The system of claim 1 wherein the entity comprises a user, and wherein the profile results are based at least in part upon the user's social graph.

9. The system of claim 1, wherein the profile results are based at least in part upon at least one of: video-related content, music-related content, game-related data, application-related data, web browsing-related data, communication-related data, transaction-related data, or personalization-related data.

10. The system of claim 1 wherein when rendered, the visualization comprises an automated tour.

11. The system of claim 1 wherein the entity corresponds to a plurality of grouped users.

12. A method comprising, collecting events associated with an entity's usage of a digital entertainment service into profile information, and automatically processing the profile information into profile results for providing at least one theme, or for rendering as at least one interactive personalized 3D visualization, or both.

13. The method of claim 12 wherein processing the profile information into the profile results comprises filtering event data in the profile information, prioritizing event data in the profile information, or classifying event data in the profile information, or any combination of filtering event data in the profile information, prioritizing event data in the profile information, or classifying event data in the profile information.

14. The method of claim 12 wherein processing the profile information into the profile results comprises accessing personal preference data to generate a public visualization.

15. The method of claim 12 wherein processing the profile information into the profile results comprises accessing outside information to influence the profile results.

16. The method of claim 12 further comprising, outputting data based upon the at least one theme or outputting data based upon the at least one interactive personalized 3D visualization, or both, receiving personal preference data, and reprocessing the profile information into modified profile results based upon the personal preference data for providing at least one modified theme, or for rendering as at least one modified interactive personalized 3D visualization.

17. The method of claim 12 wherein processing the profile information comprises generating a virtual tour corresponding to at least part of user's usage history with the digital entertainment service.

18. One or more computer-readable media having computer-executable instructions, which when executed perform steps, comprising:
generating theming data based upon profile information of an entity, the profile information corresponding to events of the entity with respect to interaction with a digital entertainment service;
generating visualization data based upon the profile information of an entity;
providing audio, visual, or audiovisual output data that uses the theming data to provide a theme for output; and
providing the visualization data for output.

19. The one or more computer-readable media of claim 18 having further computer-executable instructions comprising, receiving preference data and processing the preference data in generating the theming data and in generating the visualization data.

20. The one or more computer-readable media of claim 18 having further computer-executable instructions comprising, outputting audio, visual, or audiovisual output data as part of a theme, and outputting a visualization based upon the visualization data.
